(19) United States
(12) Patent Application Publication
(10) Pub. No.: US 2023/0422131 A1
(43) Pub. Date: Dec. 28, 2023

(54) SPECIAL CELL ACTIVATION USING LAYER 1 OR LAYER 2 SIGNALING

(71) Applicant: QUALCOMM Incorporated, San Diego, CA (US)

(72) Inventors: Shanyu ZHOU, San Diego, CA (US); Jelena DAMNJANOVIC, Del Mar, CA (US); Tao LUO, San Diego, CA (US)

(21) Appl. No.: 17/808,478

(22) Filed: Jun. 23, 2022

(51) Int. Cl. H04W 36/32; H04L 5/00

(52) U.S. Cl. CPC H04W 36/32; H04L 5/0051; H04W 80/02

(57) ABSTRACT

Various aspects of the present disclosure generally relate to wireless communication. In some aspects, a user equipment (UE) may receive a configuration of a set of cells that support at least one of layer 1 (L1) signaling mobility or layer 2 (L2) signaling mobility, wherein each cell, of the set of cells, is associated with a special cell (SpCell) configuration. The UE may receive, via one of L1 signaling or L2 signaling, an indication of a cell, of the set of cells, to serve as an SpCell. The UE may activate the cell as the SpCell based at least in part on the one of the L1 signaling or the L2 signaling and a corresponding SpCell configuration associated with the cell. Numerous other aspects are described.

### FIELD OF THE DISCLOSURE

Aspects of the present disclosure generally relate to wireless communication and to techniques and apparatuses for special cell activation using layer 1 or layer 2 signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration of a set of cells that support at least one of layer 1 (L1) signaling mobility or layer 2 (L2) signaling mobility, wherein each cell, of the set of cells, is associated with a special cell (SpCell) configuration. The method may include receiving, via one of L1 signaling or L2 signaling, an indication of a cell, of the set of cells, to serve as an SpCell. The method may include activating the cell as the SpCell based at least in part on the one of the L1 signaling or the L2 signaling and a corresponding SpCell configuration associated with the cell.

Some aspects described herein relate to a method of wireless communication performed by network node. The method may include transmitting, to a UE, a configuration of a set of cells that support at least one of L1 signaling mobility or L2 signaling mobility, wherein each cell, of the set of cells, is associated with an SpCell configuration. The method may include transmitting, to the UE via one of L1 signaling or L2 signaling, an indication of a cell, of the set of cells, to serve as an SpCell based at least in part on a corresponding SpCell configuration.

Some aspects described herein relate to an apparatus for wireless communication at a UE. The apparatus may include a memory and one or more processors coupled to the memory. The one or more processors may be configured to receive a configuration of a set of cells that support at least one of L1 signaling mobility or L2 signaling mobility, wherein each cell, of the set of cells, is associated with an SpCell configuration. The one or more processors may be configured to receive, via one of L1 signaling or L2 signaling, an indication of a cell, of the set of cells, to serve as an SpCell. The one or more processors may be configured to activate the cell as the SpCell based at least in part on the one of the L1 signaling or the L2 signaling and a corresponding SpCell configuration associated with the cell.

Some aspects described herein relate to an apparatus for wireless communication at a network node. The apparatus may include a memory and one or more processors coupled to the memory. The one or more processors may be configured to transmit, to a UE, a configuration of a set of cells that support at least one of L1 signaling mobility or L2 signaling mobility, wherein each cell, of the set of cells, is associated with an SpCell configuration. The one or more processors may be configured to transmit, to the UE via one of L1 signaling or L2 signaling, an indication of a cell, of the set of cells, to serve as an SpCell based at least in part on a corresponding SpCell configuration.

Some aspects described herein relate to a non-transitory computer-readable medium that stores a set of instructions for wireless communication by a UE. The set of instructions, when executed by one or more processors of the UE, may cause the UE to receive a configuration of a set of cells that support at least one of L1 signaling mobility or L2 signaling mobility, wherein each cell, of the set of cells, is associated with an SpCell configuration. The set of instructions, when executed by one or more processors of the UE, may cause the UE to receive, via one of L1 signaling or L2 signaling, an indication of a cell, of the set of cells, to serve as an SpCell. The set of instructions, when executed by one or more processors of the UE, may cause the UE to activate the cell as the SpCell based at least in part on the one of the L1 signaling or the L2 signaling and a corresponding SpCell configuration associated with the cell.

Some aspects described herein relate to a non-transitory computer-readable medium that stores a set of instructions for wireless communication by a network node. The set of instructions, when executed by one or more processors of the network node, may cause the network node to transmit, to a UE, a configuration of a set of cells that support at least one of L1 signaling mobility or L2 signaling mobility, wherein each cell, of the set of cells, is associated with an SpCell configuration. The set of instructions, when executed by one or more processors of the network node, may cause the network node to transmit, to the UE via one of L1 signaling or L2 signaling, an indication of a cell, of the set of cells, to serve as an SpCell based at least in part on a corresponding SpCell configuration.

Some aspects described herein relate to an apparatus for wireless communication. The apparatus may include means for receiving a configuration of a set of cells that support at least one of L1 signaling mobility or L2 signaling mobility, wherein each cell, of the set of cells, is associated with an SpCell configuration. The apparatus may include means for receiving, via one of L1 signaling or L2 signaling, an indication of a cell, of the set of cells, to serve as an SpCell. The apparatus may include means for activating the cell as the SpCell based at least in part on the one of the L1 signaling or the L2 signaling and a corresponding SpCell configuration associated with the cell.

Some aspects described herein relate to an apparatus for wireless communication. The apparatus may include means for transmitting, to a UE, a configuration of a set of cells that support at least one of L1 signaling mobility or L2 signaling mobility, wherein each cell, of the set of cells, is associated with an SpCell configuration. The apparatus may include means for transmitting, to the UE via one of L1 signaling or L2 signaling, an indication of a cell, of the set of cells, to serve as an SpCell based at least in part on a corresponding SpCell configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram illustrating an example of a configured cell set for layer 1 (L1) mobility and/or layer 2 (L2) mobility, in accordance with the present disclosure.

FIG. 6A-6D are diagrams illustrating examples of L2 signaling formats, in accordance with the present disclosure.

FIG. 7 is a diagram of an example associated with special cell activation using L1 or L2 signaling, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

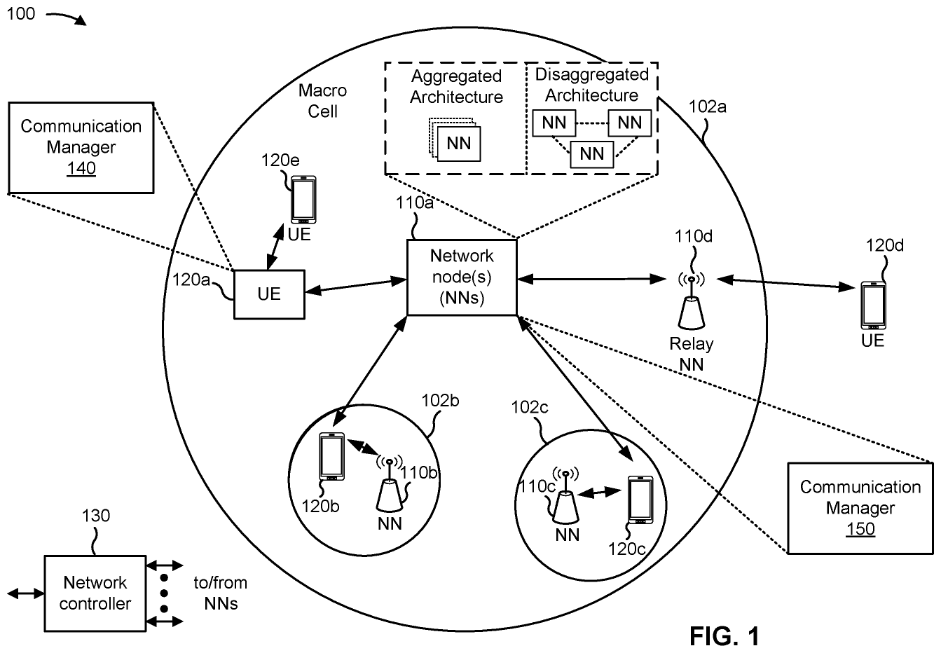

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a set of cells that support at least one of layer 1 (L1) signaling mobility or layer 2 (L2) signaling mobility, wherein each cell, of the set of cells, is associated with a special cell (SpCell) configuration; receive, via one of L1 signaling or L2 signaling, an indication of a cell, of the set of cells, to serve as an SpCell; and activate the cell as the SpCell based at least in part on the one of the L1 signaling or the L2 signaling and a corresponding SpCell configuration associated with the cell. Additionally, or alternatively, the communication manager 140 may perform one or more other operations described herein.

In some aspects, the network node 110 may include a communication manager 150. As described in more detail elsewhere herein, the communication manager 150 may transmit, to a UE (e.g., UE 120), a configuration of a set of cells that support at least one of L1 signaling mobility or L2 signaling mobility, wherein each cell, of the set of cells, is associated with an SpCell configuration; and transmit, to the UE via one of L1 signaling or L2 signaling, an indication of a cell, of the set of cells, to serve as an SpCell based at least in part on a corresponding SpCell configuration. Additionally, or alternatively, the communication manager 150 may perform one or more other operations described herein.

As indicated above, FIG. 1 is provided as an example. Other examples may differ from what is described with regard to FIG. 1.

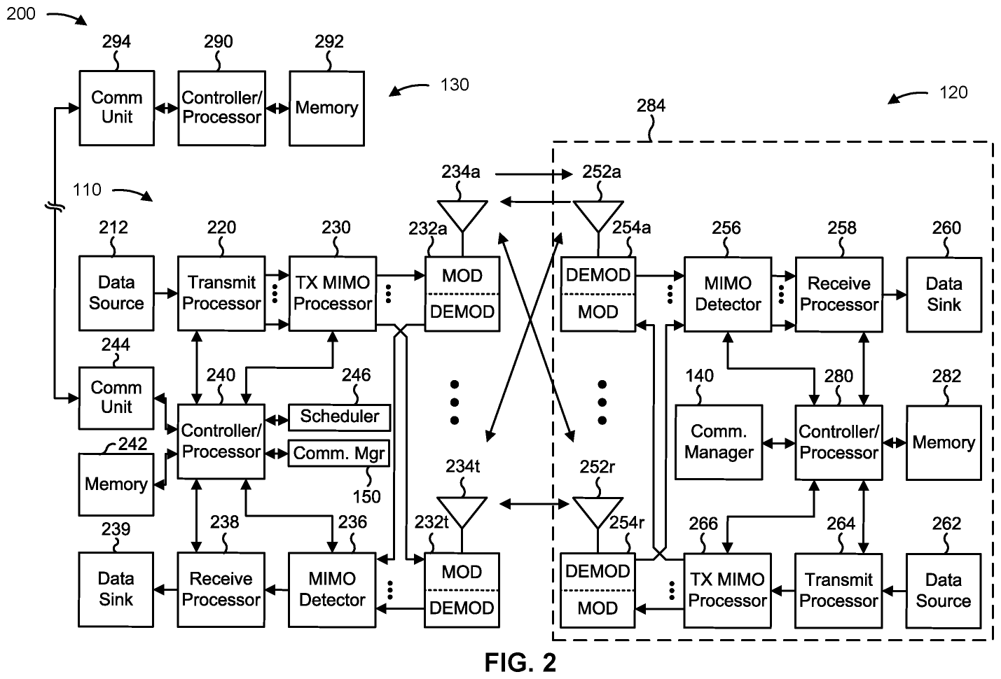

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

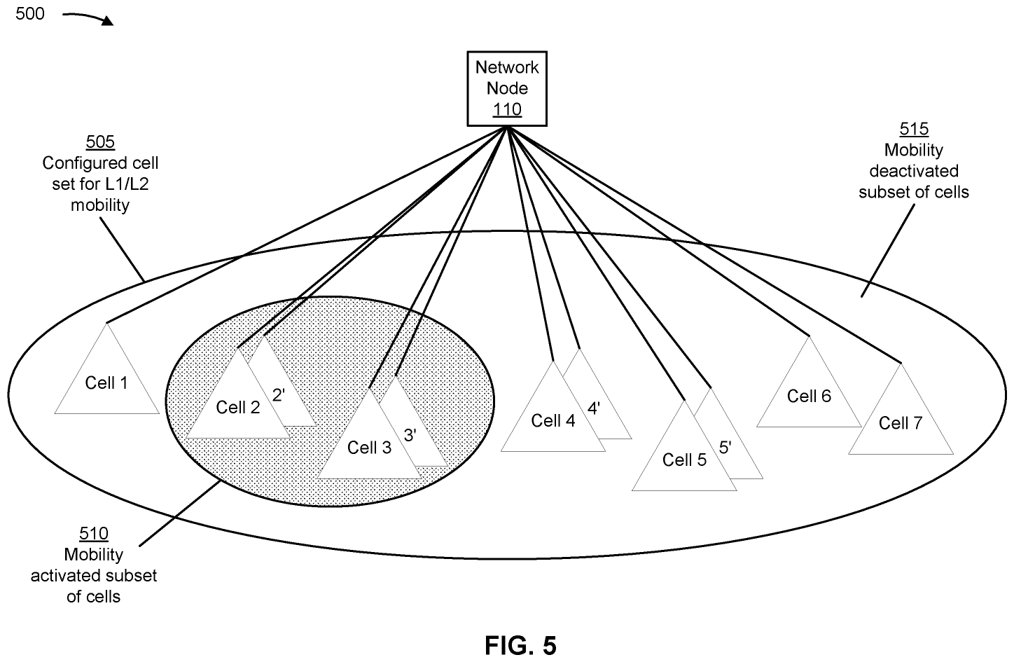

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

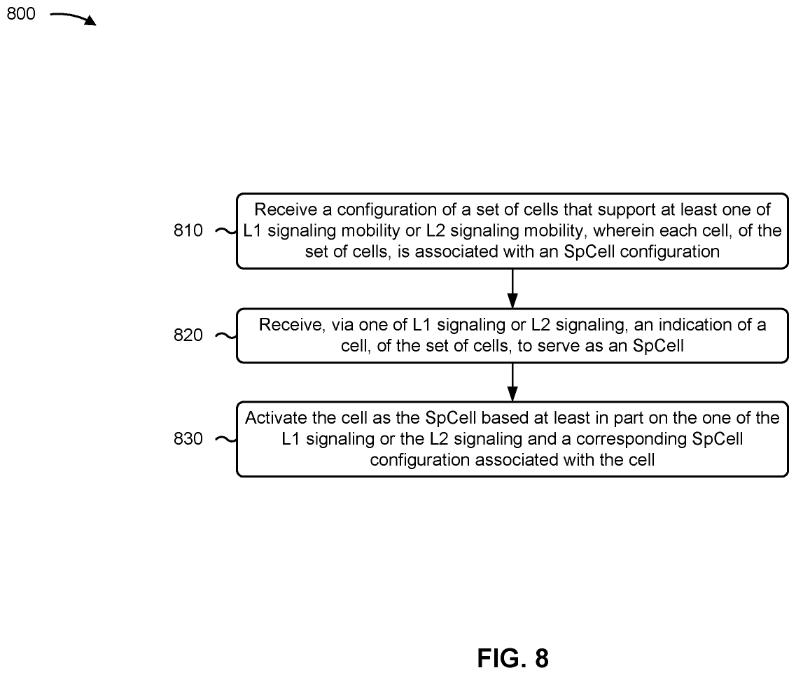

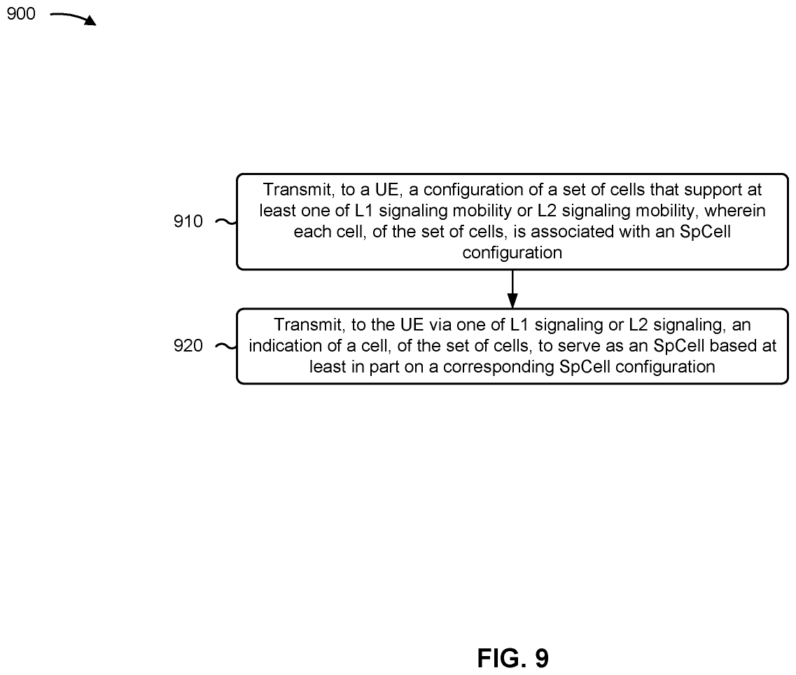

The controller/processor 240 of the network node 110, the controller/processor 280 of the UE 120, and/or any other component(s) of FIG. 2 may perform one or more techniques associated with special cell activation using layer 1 or layer 2 signaling, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving a configuration of a set of cells that support at least one of L1 signaling mobility or L2 signaling mobility, wherein each cell, of the set of cells, is associated with an SpCell configuration; means for receiving, via one of L1 signaling or L2 signaling, an indication of a cell, of the set of cells, to serve as an SpCell; and/or means for activating the cell as the SpCell based at least in part on the one of the L1 signaling or the L2 signaling and a corresponding SpCell configuration associated with the cell. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE (e.g., UE 120), a configuration of a set of cells that support at least one of L1 signaling mobility or L2 signaling mobility, wherein each cell, of the set of cells, is associated with an SpCell configuration; and/or means for transmitting, to the UE via one of L1 signaling or L2 signaling, an indication of a cell, of the set of cells, to serve as an SpCell based at least in part on a corresponding SpCell configuration. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

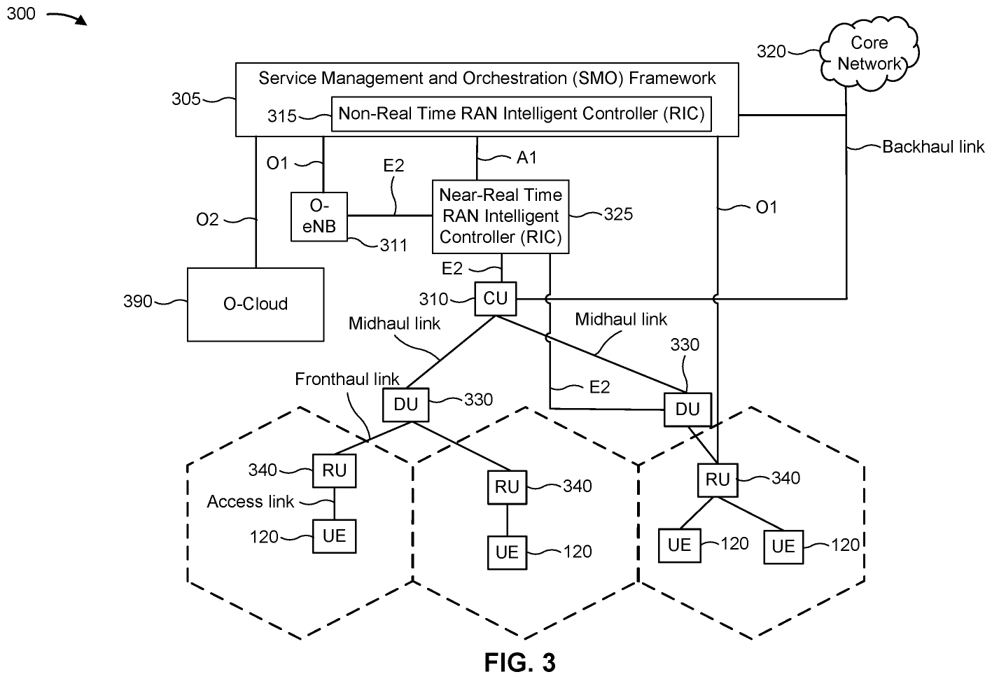

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

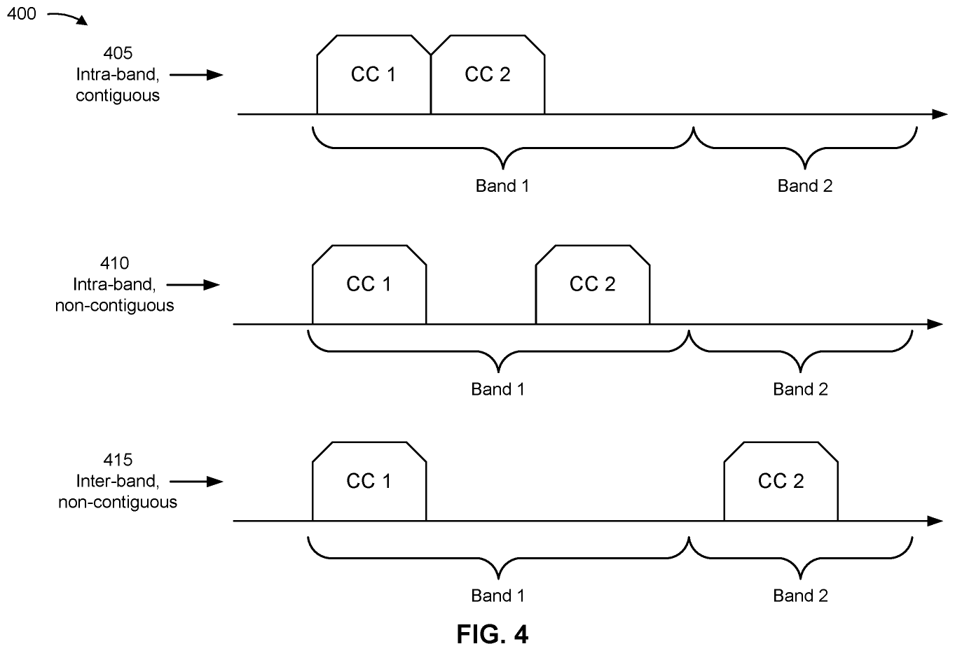

FIG. 4 is a diagram illustrating examples 400 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some instances, a UE 120 may be capable of operating in a dual connectivity mode, such as by operating in one or more of an Evolved Universal Mobile Telecommunications System Terrestrial Radio Access (E-UTRA)-NR dual connectivity (ENDC) mode (sometimes referred to as an NR or 5G non-standalone (NSA) mode), an NR-E-UTRA dual connectivity (NEDC) mode, an NR dual connectivity (NRDC) mode, or a similar dual connectivity mode. When operating in a dual connectivity mode, a UE 120 may simultaneously communicate using two cell groups, sometimes referred to as a master cell group (MCG) and a secondary cell group (SCG). In some cases, the MCG may correspond to the group of cells including a cell in which the UE 120 first initiates random access (e.g., the group of cells including the cell in which the UE 120 first performed a random access channel (RACH) procedure). In some cases, each cell group may be associated with a different RAT, while, in some other cases, each cell group may be associated with the same RAT. Put another way, the MCG is associated with a first RAT, and the SCG is associated with one of the first RAT or a second RAT different than the first RAT. For example, for an ENDC mode, the MCG is associated with an LTE RAT, and the SCG is associated with an NR RAT. For an NEDC mode, the MCG is associated with an NR RAT, and the SCG is associated with an LTE RAT. And for an NRDC mode, the MCG is associated with an NR RAT, and the SCG is also associated with the NR RAT.

In some cases, each cell group (e.g., each of the MCG and the SCG) may be associated with multiple cells, such as the multiple cells described above in connection with the carrier aggregation examples shown in FIG. 4. For example, the MCG may include a PCell and one or more SCells, and the SCG may similarly include a PCell (sometimes referred to as a primary SCG cell (PSCell)) and one or more SCells. In some instances, a PCell and/or a PSCell may be referred to as an SpCell. Put another way, an SpCell broadly refers to a primary cell of any cell group (e.g., one of an MCG or an SCG), and thus a SpCell may be a PCell or a PSCell.

In some cases, a UE 120 may be reconfigured to deactivate an SpCell as the primary cell and/or to activate an SCell as the SpCell. For example, a UE 120 may be configured to periodically measure the various cells of a cell group (e.g., an SpCell and one or more SCells) and transmit associated measurement reports to a network node 110. In some cases, if the various measurements indicate that a certain SCell (sometimes referred to as a target cell) is a better cell to serve as the SpCell than the current SpCell (sometimes referred to as a source cell), the network node 110 may initiate a handover procedure, thereby activating the target cell as the new SpCell. In such instances, the network node 110 may initiate the handover procedure by transmitting, to the UE 120, an RRC reconfiguration message (sometimes referred to as a layer 3 (L3) message and/or L3 signaling) that includes RRC configuration information for the target cell. The UE 120 may then activate the target cell as the SpCell by changing an RRC connection from the source cell to the target cell based at least in part on the RRC reconfiguration. In some cases, the previous SpCell may thereafter become an SCell.

Activating an SCell to serve as the SpCell may be a relatively slow procedure and may be associated with high signaling overhead. This is because activating the SCell to serve as the SpCell requires L3 signaling, such as the handover procedure described above, thus requiring RRC reconfiguration messages and the like every time a new cell is to serve as the SpCell. Thus, it may be difficult and/or slow to switch between primary cells, which may be particularly problematic when cells are rapidly changing. As a result, a UE 120 may be configured with a less-than-optimal SpCell and/or may be repeatedly reconfigured to switch between SpCells, resulting in high latency and overhead, and thus reduced throughput and otherwise inefficient usage of network resources.

Some techniques and apparatuses described herein enable L1 signaling (e.g., signaling received via a DCI message) and/or L2 signaling (e.g., signaling received via a MAC control element (MAC-CE) message) to activate an SCell to serve as an SpCell. For example, in some aspects, a UE may be configured with a configured cell set for L1/L2 mobility, with each cell in the configured cell set being associated with an SpCell configuration. A UE may thus seamlessly replace a cell as the SpCell in response to receiving L1 or L2 signaling by applying the corresponding SpCell configuration. For example, the UE may receive, via one of L1 signaling or L2 signaling, an indication of a cell, of the set of cells, to serve as the SpCell, and may thus activate the cell as the SpCell based at least in part on corresponding SpCell configuration. In some aspects, the UE may be further configured to perform L1 measurement and reporting for one or more deactivated SCells. For example, the UE may be configured to perform L1 measurement and reporting for each cell in the configured cell set, whether or not each cell is an activated SCell. As a result, an SCell may quickly and seamlessly be activated by L1 or L2 signaling, and/or an SCell may quickly and seamlessly replace another cell as the SpCell by L1 or L2 signaling. As a result, the UE may be configured with an optimal SpCell and/or may quickly and seamlessly switch between SpCells in response to L1 or L2 signaling, resulting in low latency and overhead as compared to L3 handover procedures, and thus increased throughput and overall more efficient usage of network resources.

As indicated above, FIG. 4 is provided as an example. Other examples may differ from what is described with regard to FIG. 4.

FIG. 5 is a diagram illustrating an example 500 of a configured cell set for L1 mobility and/or L2 mobility, in accordance with the present disclosure.

In some aspects, a UE 120 may be configured with a configured cell set for L1 and/or L2 mobility. More particularly, a UE 120 may be configured with a set of cells and corresponding SpCell configurations such that a network node 110 may signal to the UE 120 to replace an SpCell with another cell (e.g., with another activated SCell) via L1 signaling or L2 signaling, without requiring the network node 110 and/or the UE 120 to perform a handover procedure or the like (e.g., without requiring L3 signaling and/or RRC reconfiguration). For example, as shown in FIG. 5, a UE 120 may be configured with a configured cell set for L1/L2 mobility 505. The configured cell set for L1/L2 mobility 505 may include multiple cells, such as cells 1-7 in the depicted example. Moreover, in some aspects, one or more of the cells may be associated with multiple TRPs. For example, as shown in FIG. 5, cells 2-5 are each associated with multiple (e.g., two) TRPs, indicated by showing superimposed triangles at each cell, with each additional TRP indicated as cell 1′-5′, respectively. In some aspects, one of the cells and/or TRPs shown in FIG. 5 may be serving as the SpCell, with the remaining cells and TRPs being SCells.

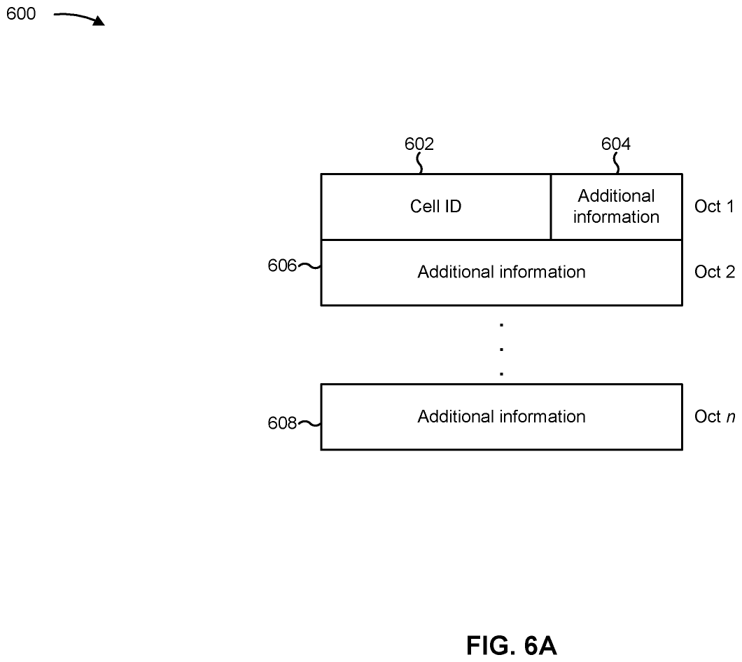

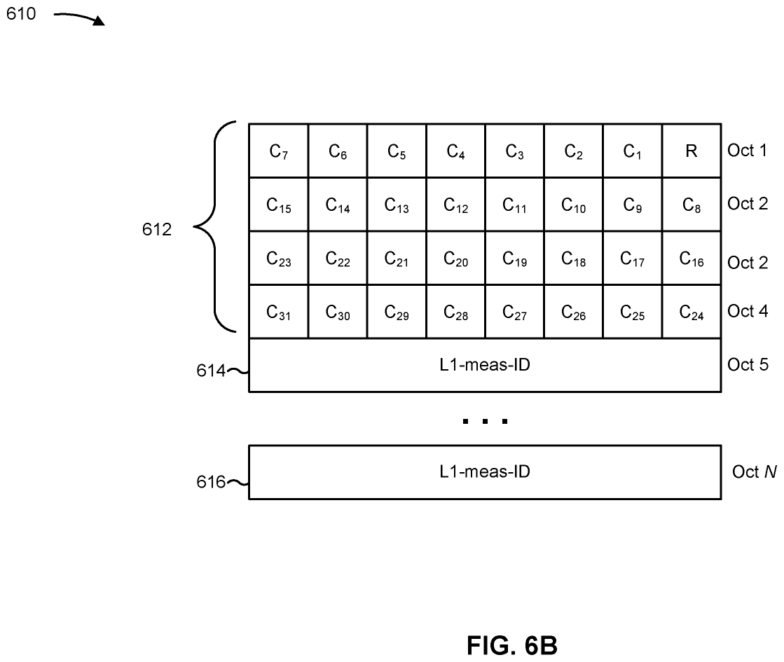

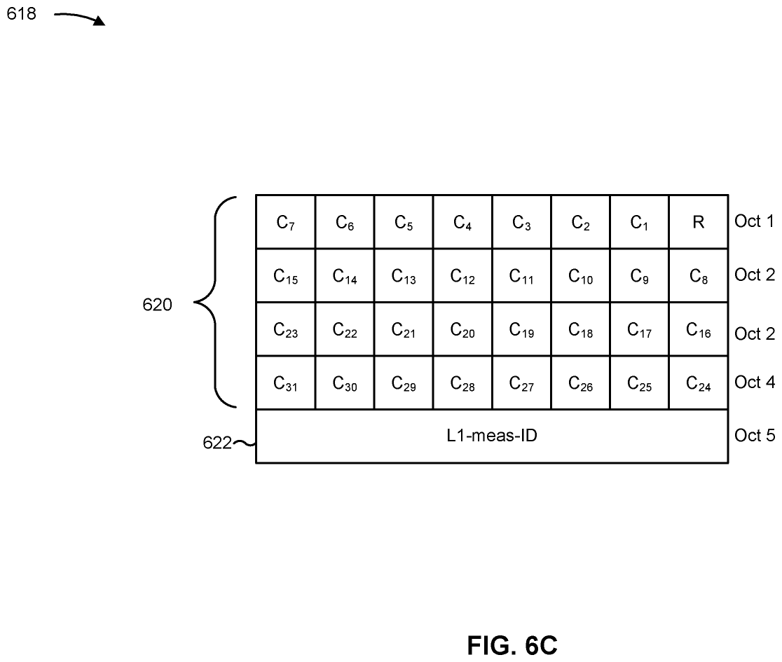

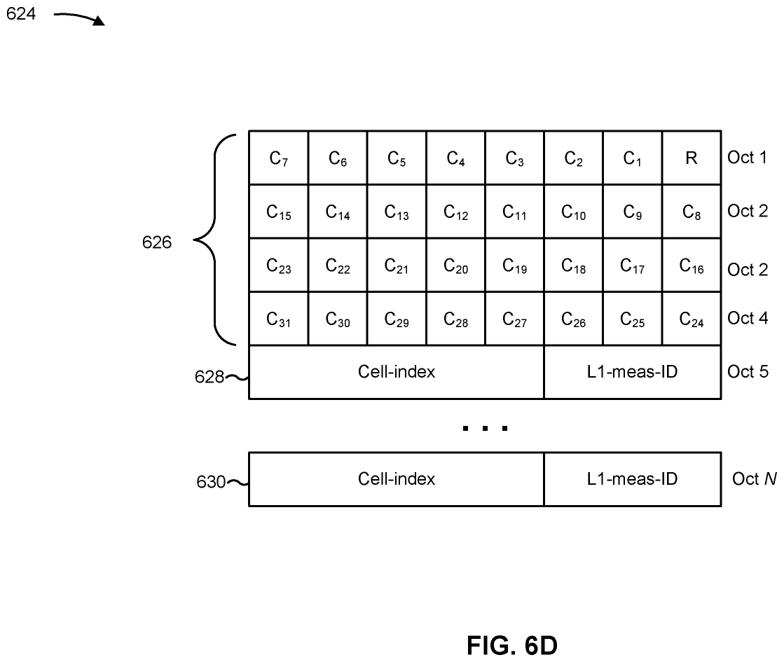

The configured cell set for L1/L2 mobility 505 may include one or more subsets of cells, such as a mobility activated subset of cells 510 and a mobility deactivated subset of cells 515. In some aspects, the mobility activated subset of cells 510 (sometimes referred to simply as activated cells) may be a group of serving cells in the configured cell set for L1/L2 mobility 505 that are activated and thus can be used for data transfer, control signaling, and/or SpCell update by L1 signaling and/or L2 signaling. The mobility deactivated subset of cells 515 (sometimes referred to simply as deactivated cells), on the other hand, may be cells within the configured cell set for L1/L2 mobility 505 that are not included in the mobility activated subset of cells 510. Put another way, the mobility deactivated subset of cells 515 may be a group of serving cells in the configured cell set for L1/L2 mobility 505 that may not be used for data transfer, control signaling, and/or SpCell update by L1 signaling and/or L2 signaling. Nonetheless, the deactivated cells may be capable of being activated (e.g., moved to the mobility activated subset of cells 510), and, once activated, used for data transfer, control signaling, and/or SpCell update by L1 signaling and/or L2 signaling. Moreover, as described in more detail below in connection with FIGS. 6B-6D, in some aspects, the cells associated with the mobility deactivated subset of cells 515 may be a group of serving cells for which L1 measurement reporting is provided by a UE 120, notwithstanding that the cells are not activated SCells.

In some aspects, a UE 120 may be configured with the configured cell set for L1/L2 mobility 505, which may include a corresponding SpCell configuration for each cell within the configured cell set for L1/L2 mobility 505. In that regard, L1 signaling and/or L2 signaling (rather than L3 signaling) may be used to update an SpCell from the configured cell set for L1/L2 mobility 505. More particularly, the network node 110 may signal to the UE 120 that the SpCell should be updated (e.g., that a cell and/or a TRP of the mobility activated subset of cells 510 should become the SpCell) via one of L1 signaling (e.g., a DCI message) or L2 signaling (a MAC-CE message), and the UE 120 may update the SpCell by applying the corresponding SpCell configuration without requiring an RRC reconfiguration message, additional L3 signaling, and/or completion of a handover procedure. Utilizing L1 signaling mobility and/or L2 signaling mobility may beneficially reduce latency as compared to legacy L3 signaling handover procedures, may result in reduced service interruption as compared to legacy L3 signaling handover procedures, may result in increased throughput as compared to legacy L3 signaling handover procedures, and may result in more efficient usage of network, computing, and power resources as compared to legacy L3 signaling handover procedures.

More particularly, L1 signaling (e.g., a DCI message) or L2 signaling (e.g., a MAC-CE message) may be used to control the activation status (e.g., the serving cell availability for data and control signaling transmission and/or reception) for cells within the configured cell set for L1/L2 mobility 505, including, in some aspects, adding a cell from the mobility deactivated subset of cells 515 to the mobility activated subset of cells 510 and/or activating a cell from the mobility activated subset of cells 510 to serve as an SpCell. Additionally, or alternatively, the L1 signaling and/or L2 signaling that activates the new SpCell may explicitly deactivate the previous SpCell from the mobility activated subset of cells 510. Put another way, in some aspects the L1 signaling and/or L2 signaling may include explicit deactivation signaling with respect to the previous SpCell and/or with respect to another SCell within the mobility activated subset of cells 510. In such aspects, when an activated SCell is deactivated from the mobility activated subset of cells 510, L1 signaling and/or L2 signaling may not thereafter be used to activate the SCell to be a new SpCell (e.g., in some aspects, an SCell may not be activated to serve as an SpCell from the mobility deactivated subset of cells 515), but nonetheless L1 and/or L2 measurement, reporting, and beam management may be still performed for the SCell based on a corresponding L1 and/or L2 mobility configuration, as described in more detail below. In such aspects, in order for a cell within the mobility deactivated subset of cells 515 to serve as an SpCell, the deactivated cell may need to be first activated to the mobility activated subset of cells 510, and thereafter activated to serve as an SpCell by one of the L1 signaling and/or the L2 signaling. In some other aspects, a previous SpCell may remain within the mobility activated subset of cells 510 as an activated SCell (e.g., the previous SpCell may remain available for data transfer, control signaling, and/or for activation to the SpCell via L1 signaling or L2 signaling).

In aspects in which L2 signaling (e.g., MAC-CE signaling) is implemented, a MAC-CE format associated with a logical channel identity (LCID) (sometimes referred to as an enhanced LCID (eLCID)) that may be specific to L2 mobility cell activation, L2 mobility cell deactivation, and/or SpCell activation may be used for signaling from the network node 110 to the UE 120, while, in aspects in which L1 signaling (e.g., DCI signaling) is implemented, a DCI format associated with L1 mobility cell activation, L1 mobility cell deactivation, and/or SpCell activation may be used for signaling from the network node 110 to the UE 120. In some aspects, the MAC-CE format and/or the DCI format may include an indication of a cell identifier of the SCell being activated as the new SpCell, such as by setting a bit corresponding to the SCell in an SpCell bitmap, or the like. Additionally, or alternatively, the MAC-CE format and/or the DCI format may include an indication of an SpCell configuration (sometimes referred as an spCellConfig) to use in aspects in which multiple configurations are available for an SCell being activated as the SpCell, such as by setting a bit corresponding to one of the available SpCell configurations in an SpCell configuration bitmap, or the like. Additionally, or alternatively, the MAC-CE format and/or the DCI format may include an indication of a transmission configuration indicator (TCI) state to use for the activated SpCell. Additionally, or alternatively, the MAC-CE format and/or the DCI format may include an indication of a reference signal to be used for a beam refinement procedure associated with the activated SpCell, or the like. Additionally, or alternatively, the MAC-CE format and/or the DCI format may include a reference signal identifier to be used for L1 measurement and reporting of any cells being deactivated (e.g., any cells being moved from the mobility activated subset of cells 510 to the mobility deactivated subset of cells 515).

Moreover, in some aspects, the cells within the configured cell set for L1/L2 mobility 505 may be configured for L1 measurement and reporting, even if not activated (e.g., both cells within the mobility activated subset of cells 510 and the mobility deactivated subset of cells 515 may be configured for L1 measurement and reporting). For cells within the mobility deactivated subset of cells 515, which may not be used for data transfer and/or control signaling, corresponding L1 measurement reports may be transmitted by the UE 120 to the network node 110 via one or more of the activated cells (e.g., one of the cells within the mobility activated subset of cells 510). In such aspects, for one or more SCells, the UE 120 may be configured (e.g., by RRC signaling) with an L1 measurement and reporting configuration to be used when the corresponding SCell is deactivated (e.g., when the corresponding SCell is within the mobility deactivated subset of cells 515). In some aspects, the network node 110 may signal to the UE 120 which L1 measurement and reporting configuration should be used upon deactivation of an SCell. For example, in some aspects, in one of L1 signaling or L2 signaling the network node 110 may indicate a specific cell identifier and a corresponding L1 measurement and reporting configuration to implement. Moreover, in some aspects, the UE 120 may be configured with a list of L1 measurement and reporting configurations, and the network node 110, using one of L1 signaling or L2 signaling, may indicate a specific configuration identifier of the L1 measurement and reporting configuration to be implemented from the list of L1 measurement and reporting configurations. Aspects of indicating a specific L1 measurement and reporting configuration to be implemented are described in more detail below in connection with FIGS. 6B-6D.

In this way, the network node 110 may be provided measurements regarding both activated and deactivated cells, and the network node 110 may flexibly activate or deactivate certain cells via L1 signaling or L2 signaling and/or signal that a certain activated cell should serve as the SpCell via L1 signaling or L2 signaling, without requiring relatively slow and overhead-intensive RRC signaling. Aspects of the various L1 signaling or L2 signaling used to activate SpCells and/or to enable L1 measurement and reporting of deactivated SCells are described in more detail below in connection with FIGS. 6A-6D.

As indicated above, FIG. 5 is provided as an example. Other examples may differ from what is described with regard to FIG. 5.

FIG. 6A-6D are diagrams illustrating examples 600, 610, 618, and 624 of L2 signaling formats, in accordance with the present disclosure.

First, FIG. 6A shows an example 600 of a MAC-CE format that may be used for SpCell activation. The MAC-CE format of example 600 may include n octets (labeled as “Oct” in FIG. 6A). The first octet (e.g., “Oct 1”) may include a cell identifier field 602 and an additional information field 604. In some aspects, the cell identifier field 602 may include a number of bits used to specify an SCell index of an SCell that is being activated as the SpCell. For example, in some aspects, the cell identifier field 602 may include five bits, which thus may be used indicate one cell index of up to 32 cell indexes corresponding to the SCell that is being activated as the SpCell. The first octet and each subsequent octet may include additional information fields (e.g., the additional information field 604 associated with the first octet, an additional information field 606 associated with the second octet (“Oct 2”), an additional information field 608 associated with the n-th octet (“Oct n”), and so forth).

In some aspects, the additional information fields 604, 606, 608 may indicate other information (e.g., information in addition to the SCell index) regarding the newly activated SpCell. For example, the additional information fields 604, 606, 608 may indicate a selected SpCell configuration to implement, if the UE 120 is configured with multiple SpCell configurations. In some aspects, the selected SpCell configuration may be indicated by indicating an SpCell configuration identifier (e.g., spCellConfig) in the additional information fields 604, 606, 608. Additionally, or alternatively, the additional information fields 604, 606, 608 may indicate a TCI state to activate for the activated SpCell, a reference signal to be used for a beam refinement procedure, and/or a reference signal identifier to be used for L1 measurement reporting of any cells being deactivated.

Next, FIG. 6B shows an example 610 of a MAC-CE format that may be used for L1 measurement and reporting configuration for deactivated SCells (e.g., SCells associated with the mobility deactivated subset of cells 515). In some aspects, the MAC-CE format depicted in FIG. 6B may be referred to as an enhanced SCell activation/deactivation MAC-CE. The MAC-CE format of example 610 may include N octets. The first four octets (e.g., “Oct 1” through “Oct 4”), indicated by reference number 612, may indicate up to 31 SCells to be deactivated in response to the UE 120 receiving the MAC-CE message shown in FIG. 6B. More particularly, the first four octets collectively include 31 cell fields (indexed as C₁ through C₃₁) and one reserved field (shown with an R in FIG. 6B). Each cell field may include a one bit indicator indicating whether a corresponding SCell should be deactivated (e.g., included in the mobility deactivated subset of cells 515). For example, the cell fields C₁, C₄, C₁₈, and C₂₇ may include one of a “1” bit or a “0” bit, indicating that SCells corresponding to the cell indexes C₁, C₄, C₁₈, and C₂₇ should be included in the mobility deactivated subset of cells 515, while the remaining cell fields (e.g., C₂-C₃, C₅-C₁₇, C₁₉-C₂₆, and C₂₈-C₃₁) may include the other of the “1” bit or the “0” bit, indicating that SCells corresponding to the cell indexes C₂-C₃, C₅-C₁₇, C₁₉-C₂₆, and C₂₈-C₃₁ should be included in the mobility activated subset of cells 510.

The MAC-CE format shown in FIG. 6B may include m additional octets (e.g., octet 5, indicated by reference number 614, through octet N, indicated by reference number 616), with m being equal to N−4 and corresponding to the number of deactivated cells specified in octets 1-4. Thus, returning to the above example in which the SCells corresponding to fields C₁, C₄, C₁₈, and C₂₇ are deactivated, the MAC-CE format shown in FIG. 6B may include four additional octets. Each additional octet (e.g., octet 5 through octet N) may correspond to one deactivated cell index, in ascending order. Thus, the first additional octet, octet 5, may correspond to the lowest deactivated cell index (e.g., C₁ in the above example), followed by octets corresponding to the remaining cell indexes in ascending order with the last additional octet, octet N, corresponding to the highest deactivated cell index (e.g., C₂₇ in the above example).

In some aspects, each additional octet (e.g., octet 5 through octet N) may indicate an L1 measurement and reporting configuration identifier (sometimes referred to as L1-meas-ID) that points to a specific L1 measurement and reporting setting, previously configured by RRC signaling or the like, applicable to the corresponding deactivated SCell. Thus, in the example in which the SCells corresponding to fields C₁, C₄, C₁₈, and C₂₇ are deactivated, octet 5 (e.g., Oct 5) may include an L1 measurement and reporting configuration identifier corresponding to an L1 measurement and reporting setting applicable to the SCell corresponding to field C₁, octet 6 may include an L1 measurement and reporting configuration identifier corresponding to an L1 measurement and reporting setting applicable to the SCell corresponding to field C₄, octet 7 may include an L1 measurement and reporting configuration identifier corresponding to an L1 measurement and reporting setting applicable to the SCell corresponding to field C₁₈, and octet 8 (which, in this example, would correspond to Oct N) may include an L1 measurement and reporting configuration identifier corresponding to an L1 measurement and reporting setting applicable to the SCell corresponding to field C₂₇. In some aspects, each additional octet (e.g., octet 5 through octet N) may include eight bits, and thus may indicate one of up to 256 different L1 measurement and reporting configurations applicable to the corresponding deactivated SCell.

FIG. 6C shows another example 618 of a MAC-CE format that may be used for L1 measurement and reporting configuration for deactivated SCells (e.g., SCells associated with the mobility deactivated subset of cells 515), which may be a truncated version of the example 610 MAC-CE format described in connection with FIG. 6B. In some aspects, the MAC-CE format depicted in FIG. 6B may be referred to as a truncated enhanced SCell activation/deactivation MAC-CE. The MAC-CE format of example 618 may include 5 octets. The first four octets (e.g., “Oct 1” through “Oct 4”), indicated by reference number 620, may indicate the same information as described in connection with the first four octets of the example 610 shown in FIG. 6B, indicated by reference number 612. In this aspect, however, the MAC-CE format may include a single additional octet (e.g., octet 5, indicated by reference number 622).

In a similar manner as described in connection with octets 5 through N of example 610, the additional octet (e.g., octet 5) may indicate an L1 measurement and reporting configuration identifier (e.g., L1-meas-ID) that points to a specific L1 measurement and reporting setting, previously configured by RRC signaling or the like, applicable to the corresponding deactivated SCells. In this aspect, however, each deactivated cell may use the same configuration identifier for L1 measurement and reporting. Put another way, the L1 measurement and reporting configuration identifier (e.g., L1-meas-ID) indicated by octet 5 may apply to every deactivated SCell (e.g., each of the SCells corresponding to fields C₁, C₄, C₁₈, and C₂₇ in the above example). The MAC-CE format shown in FIG. 6C may beneficially reduce a payload size of the enhanced SCell activation/deactivation MAC-CE, and thus may be particularly useful in aspects in which physical downlink shared channel (PDSCH) space is limited, or the like. Moreover, in some aspects, two or more deactivated SCells may be configured (e.g., by RRC signaling, or the like) with different L1 measurement and reporting configurations to use in the deactivated state. In such aspects, even though the L1 measurement and reporting configuration identifier (e.g., L1-meas-ID) may be the same for each deactivated SCell, the corresponding configuration details may be different across each SCell.

Finally, FIG. 6D shows an example 624 of a MAC-CE format that may be used for L1 measurement and reporting configuration for deactivated SCells (e.g., SCells associated with the mobility deactivated subset of cells 515). In some aspects, the MAC-CE format depicted in FIG. 6D may be referred to as an enhanced SCell activation/deactivation MAC-CE. The MAC-CE format of example 624 may include N octets. The first four octets (e.g., “Oct 1” through “Oct 4”), indicated by reference number 626, may indicate the same information as described in connection with the first four octets of the example 610 shown in FIG. 6B, indicated by reference number 612, and/or the first four octets of the example 618 shown in FIG. 6C, indicated by reference number 620.

The MAC-CE format shown in FIG. 6D may include p additional octets (e.g., octet 5, indicated by reference number 628, through octet N, indicated by reference number 630), with p being equal to N−4 and corresponding to the number of deactivated cells for which a particular L1 measurement and reporting configuration is specified by the MAC-CE format. Thus, in some aspects, p may be less than the number of deactivated SCells indicated by octets 1-4, such as in aspects in which the network node 110 indicates an L1 measurement and reporting configuration for less than all of the deactivated SCell indicated by octets 1-4. More particularly, each additional octet may include a cell identifier field (sometimes referred to as Cell-index) and an L1 measurement and reporting configuration identifier field (e.g., L1-meas-ID). In some aspects, the cell identifier field may include five bits, and may be used to point to a deactivate cell for which the corresponding L1 measurement and reporting configuration identifier applies. The L1 measurement and reporting configuration identifier field may include three bits, and thus may be used to indicate one of up to eight different L1 measurement and reporting configurations applicable to the deactivated SCell indicated by the cell identifier field.

In some aspects, for any deactivated SCells that are not specified in the additional octets (e.g., any deactivated SCell indicated by octets 1-4, but for which there is no corresponding octet in the additional octets 5-N), the UE 120 may not perform L1 measurement and reporting. Put another way, the network node 110 may indicate to the UE 120 that L1 measurement and reporting should not be performed for a given deactivated SCell by omitting an additional octet that indicates a cell index corresponding to the given deactivated SCell. In some other aspects, for any deactivated SCells that are not specified in the additional octets (e.g., any deactivated SCell indicated by octets 1-4, but for which there is no corresponding octet in the additional octets 5-N), the UE 120 may apply a default L1 measurement and reporting configuration. For example, in some aspects, the default L1 measurement and reporting configuration may be a configuration indexed as zero (e.g., the default L1 measurement and reporting configuration may correspond to the L1 measurement and reporting configuration associated with L1-meas-ID=0 in an RRC configured identifier list).

As indicated above, FIGS. 6A-6D are provided as examples. Other examples may differ from what is described with regard to FIGS. 6A-6D.

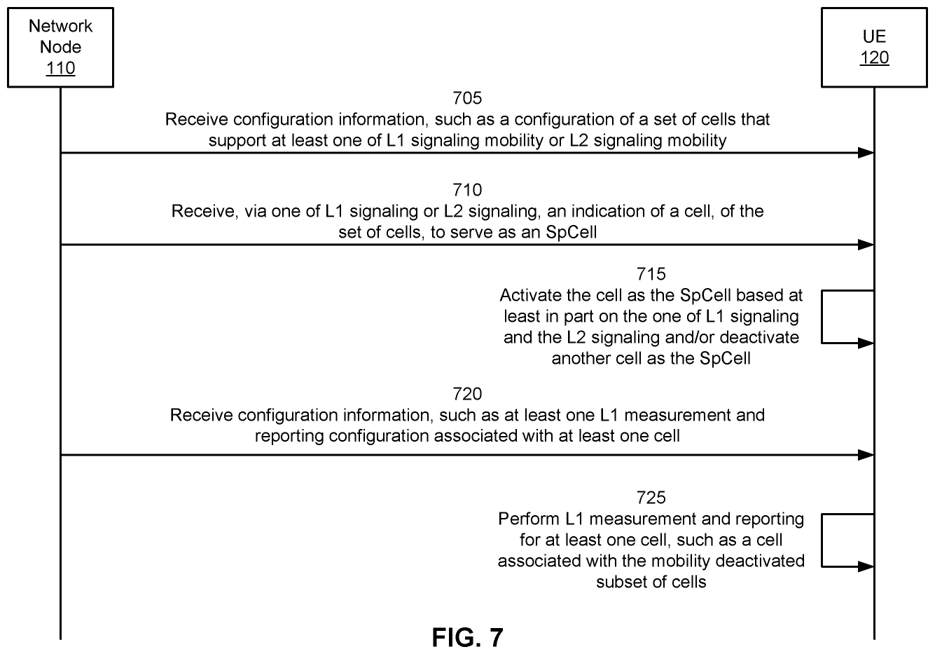

FIG. 7 is a diagram of an example 700 associated with SpCell activation using L1 or L2 signaling, in accordance with the present disclosure. As shown in FIG. 7, a network node 110 may communicate with a UE 120. In some aspects, the network node 110 and the UE 120 may be part of a wireless network (e.g., wireless network 100). The network node 110 and the UE 120 may have established a wireless connection prior to operations shown in FIG. 7.

As shown by reference number 705, the UE 120 may receive, from the network node 110, configuration information. In some aspects, the UE 120 may receive the configuration information via one or more of RRC signaling (e.g., L3 signaling), one or more MAC-CEs (e.g., L2 signaling), and/or DCI (e.g., L1 signaling), among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may include a configuration of a set of cells that support at least one of L1 signaling mobility or layer L2 signaling mobility (e.g., a set of cells that may be activated and/or deactivated as a SpCell using L1 signaling and/or L2 signaling, instead of L3 signaling, such as in connection with a legacy handover procedure). For example, in some aspects, the configuration information may indicate the configured cell set for L1/L2 mobility 505 described in connection with FIG. 5. In that regard, in some aspects, the set of cells may include a mobility activated subset of cells (e.g., the mobility activated subset of cells 510) and a mobility deactivated subset of cells (e.g., the mobility activated subset of cells 510). Moreover, in some aspects, the configuration information may include SpCell configurations for each cell, of the set of cells. Put another way, the configuration information may pre-configure each cell with a corresponding SpCell configuration, such that each cell of the set of cells that support at least one of L1 signaling mobility or layer L2 signaling mobility may be quickly and seamlessly activated as the SpCell using L1 signaling or L2 signaling by applying the corresponding pre-configured SpCell configuration, as described above in connection with FIGS. 5-6A. The UE 120 may configure itself based at least in part on the configuration information. In some aspects, the UE 120 may be configured to perform one or more operations described herein based at least in part on the configuration information. In some aspects, the UE 120 may transmit, to the network node 110, an acknowledgement message indicating that the configuration information described in connection with reference number 705 was received by the UE 120.

As shown by reference number 710, in some aspects, the UE 120 may receive, from the network node 110 and via one of L1 signaling or L2 signaling, an indication of a cell, of the set of cells, to serve as an SpCell. In some aspects, the cell may be associated with the mobility activated subset of cells. More particularly, the network node 110 may quickly and seamlessly activate as the SpCell an activated SCell by using one of L1 signaling (e.g., DCI) or L2 signaling (e.g., MAC-CE), rather than L3 signaling (e.g., an RRC reconfiguration message). For example, the one of the L1 signaling or the L2 signaling may include one of a LCID (e.g., an eLCID), a MAC-CE format, and/or a DCI format indicating at least one of a cell identifier associated with the cell to serve as the SpCell, an SpCell configuration associated with the cell, a TCI state associated with the cell, a reference signal associated with a beam management procedure associated with the cell, or a reference signal identifier associated with L1 measurement and reporting of a previous SpCell that is being deactivated as the SpCell in response to activating the cell as the SpCell. For example, this information may be indicated using the MAC-CE format described in connection with FIG. 6A. Moreover, in some aspects, the L1 signaling or the L2 signaling described in connection with reference number 710 may indicate additional cells that should be activated (e.g., added to the mobility activated subset of cells 510) or deactivated (e.g., added to the mobility deactivated subset of cells). For example, the UE 120 may receive, from the network node 110 and via the one of the L1 signaling or the L2 signaling, an indication that another cell associated with the mobility deactivated subset of cells should be added to the mobility activated subset of cells and/or an indication that another cell associated with the mobility activated subset of cells should be added to the mobility deactivated subset of cells.

Based at least in part on the one of the L1 signaling or the L2 signaling, and as shown by reference number 715, the UE 120 may activate the cell as the SpCell based at least in part on the corresponding SpCell configuration associated with the cell. Put another way, in response to L1 signaling or L2 signaling from the network node 110, the UE 120 may activate an SCell as the SpCell by applying the pre-configured SpCell configuration associated with the SCell being activated. In some aspects, the UE 120 may correspondingly deactivate another cell as the SpCell based at least in part on activating the cell as the SpCell. That is, the UE 120 may replace a cell acting as the SpCell with another cell. In such aspects, the previous SpCell may either become associated with the mobility activated subset of cells when it is deactivated as the SpCell, or else the previous SpCell may become associated with the mobility deactivated subset of cells when it is deactivated as the SpCell. In some aspects, the network node 110 may indicate whether the previous SpCell should become associated with the mobility activated subset of cells or the mobility deactivated subset of cells. For example, in some aspects, the UE 120 may receive, via the one of the L1 signaling or the L2 signaling described in connection with reference number 710, an indication that the previous SpCell should become associated with the mobility activated subset of cells or the mobility deactivated subset of cells.

In some aspects, as described above in connection with FIGS. 5 and 6B-6D, the UE 120 may perform L1 measurement and reporting for at least one cell associated with the mobility deactivated subset of cells (e.g., for at least one deactivated SCell). Accordingly, in some aspects, and as shown by reference number 720, the UE 120 may receive additional configuration information configuring L1 measurement and reporting for at least one deactivated SCell. The configuration information shown by reference number 720 may be transmitted to the UE 120 as part of the same configuration message associated with the configuration information described in connection with reference number 705 (e.g., the configuration information described in connection with reference numbers 705 and 720 may be transmitted in the same RRC message), or else the configuration information shown by reference number 720 may be transmitted to the UE 120 using a different configuration message than the message associated with the configuration information described in connection with reference number 705.

In some aspects, the configuration information shown by reference number 720 may indicate at least one L1 measurement and reporting configuration associated with the at least one cell (e.g., at least one deactivated SCell). In some aspects, the configuration information may indicate multiple L1 measurement and reporting configurations, and the UE 120 may select one of the multiple L1 measurement and reporting configurations to apply to given cell based at least in part on additional signaling received from the network node 110, such as an indication included in L1 signaling or L2 signaling. More particularly, in some aspects, the UE 120 may receive an indication of a selected L1 measurement and reporting configuration, of the multiple L1 measurement and reporting configurations, associated with a particular cell.

In some aspects, an indication of a selected L1 measurement and reporting configuration to apply to a given cell (e.g., to a particular deactivated SCell) may be indicated using L2 signaling, such as one of the MAC-CE formats described in connection with FIGS. 6B-6D, that indicates one or more L1 measurement and reporting configurations associated with one or more deactivated cells, of the set of cells. For example, and as described in connection with FIG. 6B, in some aspects, the MAC-CE communication may indicate, for each deactivated cell, a corresponding L1 measurement and reporting configuration identifier. More particularly, the corresponding L1 measurement and reporting configuration identifier for each deactivated cell may be indicated using a corresponding octet in the MAC-CE communication, such as octets 5-N described in connection with FIG. 6B.

In some other aspects, and as described in connection with FIG. 6C, the MAC-CE communication may indicate a single L1 measurement and reporting configuration identifier associated with the one or more deactivated cells. More particularly, the single L1 measurement and reporting configuration identifier may be indicated using a single octet in the MAC-CE communication, such as octet 5 described in connection with FIG. 6C.

In some other aspects, and as described in connection with FIG. 6D, the MAC-CE communication may indicate, for each cell of a subset of the one or more deactivated cells, a corresponding L1 measurement and reporting configuration identifier. In such aspects, the corresponding L1 measurement and reporting configuration identifier for each deactivated cell, of the subset of the one or more deactivated cells, may be indicated using a corresponding octet in the MAC-CE communication that includes a cell index field and a L1 measurement and reporting configuration identifier field, such as octets 5-N described in connection with FIG. 6D.

As shown by reference number 725, the UE 120 may perform L1 measurement and reporting for at least one cell based at least in part on the L1 measurement and reporting configuration. For example, the UE 120 may perform L1 measurement and reporting for at least one cell associated with the mobility deactivated subset of cells (e.g., a deactivated SCell).

Based at least in part on the network node 110 signaling SpCell activation using L1 signaling or L2 signaling, the UE 120 and/or the network node 110 may conserve computing, power, network, and/or communication resources that may have otherwise been consumed by legacy handover procedures or the like that require RRC reconfiguration or similar L3 signaling. For example, based at least in part on the network node 110 signaling SpCell activation using L1 signaling or L2 signaling, the UE 120 and the network node 110 may communicate with reduced RRC overhead and may switch between SpCells with reduced latency, which may conserve computing, power, network, and/or communication resources that may have otherwise been consumed to perform overhead-intensive and slow RRC-based handover or similar procedures.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with special cell activation using layer 1 or layer 2 signaling.

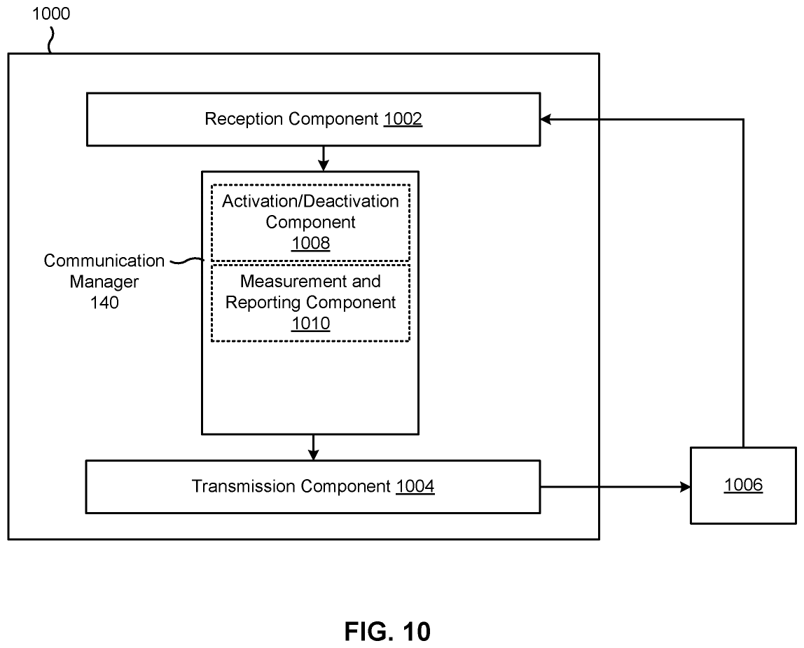

As shown in FIG. 8, in some aspects, process 800 may include receiving a configuration of a set of cells that support at least one of L1 signaling mobility or L2 signaling mobility, wherein each cell, of the set of cells, is associated with an SpCell configuration (block 810). For example, the UE (e.g., using communication manager 140 and/or reception component 1002, depicted in FIG. 10) may receive a configuration of a set of cells that support at least one of L1 signaling mobility or L2 signaling mobility, wherein each cell, of the set of cells, is associated with an SpCell configuration, as described above.

As further shown in FIG. 8, in some aspects, process 800 may include receiving, via one of L1 signaling or L2 signaling, an indication of a cell, of the set of cells, to serve as an SpCell (block 820). For example, the UE (e.g., using communication manager 140 and/or reception component 1002, depicted in FIG. 10) may receive, via one of L1 signaling or L2 signaling, an indication of a cell, of the set of cells, to serve as an SpCell, as described above.

As further shown in FIG. 8, in some aspects, process 800 may include activating the cell as the SpCell based at least in part on the one of the L1 signaling or the L2 signaling and a corresponding SpCell configuration associated with the cell (block 830). For example, the UE (e.g., using communication manager 140 and/or activation/deactivation component 1008, depicted in FIG. 10) may activate the cell as the SpCell based at least in part on the one of the L1 signaling or the L2 signaling and a corresponding SpCell configuration associated with the cell, as described above.

Process 800 may include additional aspects, such as any single aspect or any combination of aspects described below and/or in connection with one or more other processes described elsewhere herein.

In a first aspect, the set of cells includes a mobility activated subset of cells and a mobility deactivated subset of cells, and the cell is associated with the mobility activated subset of cells.

In a second aspect, alone or in combination with the first aspect, process 800 includes receiving, via the one of the L1 signaling or the L2 signaling, an indication that another cell associated with the mobility deactivated subset of cells should be added to the mobility activated subset of cells.

In a third aspect, alone or in combination with one or more of the first and second aspects, process 800 includes deactivating another cell, of the set of cells, as the SpCell based at least in part on activating the cell as the SpCell, wherein the other cell becomes associated with the mobility activated subset of cells based at least in part on deactivating the other cell as the SpCell.

In a fourth aspect, alone or in combination with one or more of the first through third aspects, process 800 includes deactivating another cell, of the set of cells, as the SpCell based at least in part on activating the cell as the SpCell, wherein the other cell becomes associated with the mobility deactivated subset of cells based at least in part on deactivating the other cell as the SpCell.

In a fifth aspect, alone or in combination with one or more of the first through fourth aspects, process 800 includes receiving, via the one of the L1 signaling or the L2 signaling, an indication that the other cell should become associated with the mobility deactivated subset of cells.

In a sixth aspect, alone or in combination with one or more of the first through fifth aspects, process 800 includes performing, for at least one cell associated with the mobility deactivated subset of cells, L1 measurement and reporting.

In a seventh aspect, alone or in combination with one or more of the first through sixth aspects, process 800 includes receiving at least one L1 measurement and reporting configuration associated with the at least one cell.

In an eighth aspect, alone or in combination with one or more of the first through seventh aspects, process 800 includes receiving multiple L1 measurement and reporting configurations, and receiving an indication of a selected L1 measurement and reporting configuration, of the multiple L1 measurement and reporting configurations, associated with the at least one cell.

In a ninth aspect, alone or in combination with one or more of the first through eighth aspects, the one of the L1 signaling or the L2 signaling includes one of a logical channel identity or a downlink control information format indicating at least one of a cell identifier associated with the cell, an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

In a tenth aspect, alone or in combination with one or more of the first through ninth aspects, the one of the L1 signaling or the L2 signaling is associated with a MAC-CE communication or a downlink control information communication.

In an eleventh aspect, alone or in combination with one or more of the first through tenth aspects, the one of the L1 signaling or the L2 signaling is associated with the MAC-CE communication, and the MAC-CE communication includes a cell identifier field indicating an index of the cell, and an additional information field indicating one or more of an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

In a twelfth aspect, alone or in combination with one or more of the first through eleventh aspects, the one of the L1 signaling or the L2 signaling is associated with the MAC-CE communication, and the MAC-CE communication indicates one or more L1 measurement and reporting configurations associated with one or more deactivated cells, of the set of cells.

In a thirteenth aspect, alone or in combination with one or more of the first through twelfth aspects, the MAC-CE communication indicates, for each deactivated cell, of the one or more deactivated cells, a corresponding L1 measurement and reporting configuration identifier.

In a fourteenth aspect, alone or in combination with one or more of the first through thirteenth aspects, the corresponding L1 measurement and reporting configuration identifier for each deactivated cell is indicated using a corresponding octet in the MAC-CE communication.

In a fifteenth aspect, alone or in combination with one or more of the first through fourteenth aspects, the MAC-CE communication indicates a single L1 measurement and reporting configuration identifier associated with the one or more deactivated cells.

In a sixteenth aspect, alone or in combination with one or more of the first through fifteenth aspects, the single L1 measurement and reporting configuration identifier is indicated using a single octet in the MAC-CE communication.

In a seventeenth aspect, alone or in combination with one or more of the first through sixteenth aspects, the MAC-CE communication indicates, for each deactivated cells, of a subset of the one or more deactivated cells, a corresponding L1 measurement and reporting configuration identifier.

In an eighteenth aspect, alone or in combination with one or more of the first through seventeenth aspects, the corresponding L1 measurement and reporting configuration identifier for each deactivated cell, of the subset of the one or more deactivated cells, is indicated using a corresponding octet in the MAC-CE communication that includes a cell index field and a L1 measurement and reporting configuration identifier field.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with special cell activation using layer 1 or layer 2 signaling.

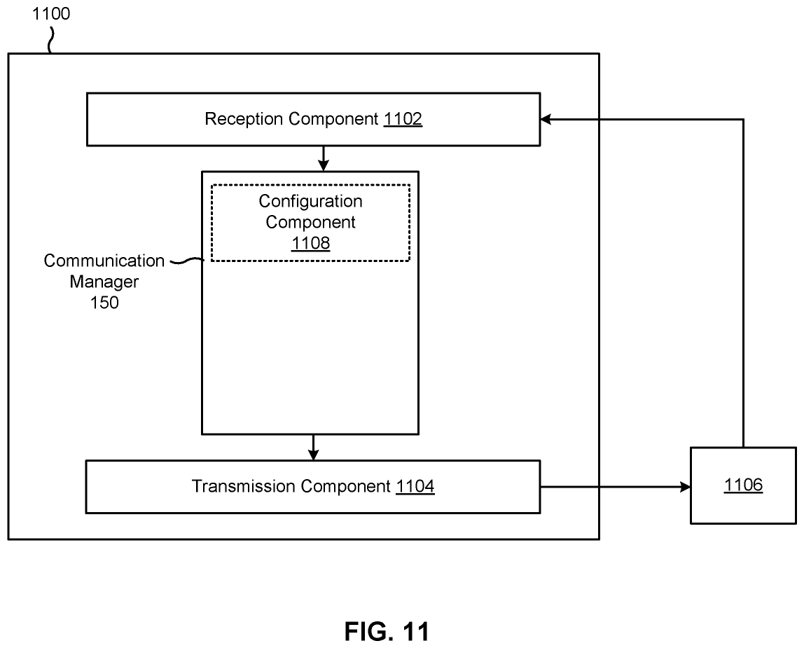

As shown in FIG. 9, in some aspects, process 900 may include transmitting, to a UE (e.g., UE 120), a configuration of a set of cells that support at least one of L1 signaling mobility or L2 signaling mobility, wherein each cell, of the set of cells, is associated with an SpCell configuration (block 910). For example, the network node (e.g., using communication manager 150 and/or transmission component 1104, depicted in FIG. 11) may transmit, to a UE, a configuration of a set of cells that support at least one of L1 signaling mobility L2 signaling mobility, wherein each cell, of the set of cells, is associated with an SpCell configuration, as described above.

As further shown in FIG. 9, in some aspects, process 900 may include transmitting, to the UE via one of L1 signaling or L2 signaling, an indication of a cell, of the set of cells, to serve as an SpCell based at least in part on a corresponding SpCell configuration (block 920). For example, the network node (e.g., using communication manager 150 and/or transmission component 1104, depicted in FIG. 11) may transmit, to the UE via one of L1 signaling or L2 signaling, an indication of a cell, of the set of cells, to serve as an SpCell based at least in part on a corresponding SpCell configuration, as described above.

Process 900 may include additional aspects, such as any single aspect or any combination of aspects described below and/or in connection with one or more other processes described elsewhere herein.

In a first aspect, the set of cells includes a mobility activated subset of cells and a mobility deactivated subset of cells, and the cell is associated with the mobility activated subset of cells.

In a second aspect, alone or in combination with the first aspect, process 900 includes transmitting, to the UE via the one of the L1 signaling or the L2 signaling, an indication that another cell associated with the mobility deactivated subset of cells should be added to the mobility activated subset of cells.

In a third aspect, alone or in combination with one or more of the first and second aspects, process 900 includes transmitting, to the UE via the one of the L1 signaling or the L2 signaling, an indication that a previous SpCell should become associated with the mobility deactivated subset of cells.

In a fourth aspect, alone or in combination with one or more of the first through third aspects, process 900 includes transmitting, to the UE, at least one L1 measurement and reporting configuration associated with at least one cell associated with the mobility deactivated subset of cells.

In a fifth aspect, alone or in combination with one or more of the first through fourth aspects, process 900 includes transmitting, to the UE, multiple L1 measurement and reporting configurations, and transmitting, to the UE, an indication of a selected L1 measurement and reporting configuration, of the multiple L1 measurement and reporting configurations, associated with the at least one cell.

In a sixth aspect, alone or in combination with one or more of the first through fifth aspects, the one of the L1 signaling or the L2 signaling includes one of a logical channel identity or a downlink control information format indicating at least one of a cell identifier associated with the cell, an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

In a seventh aspect, alone or in combination with one or more of the first through sixth aspects, the one of the L1 signaling or the L2 signaling is associated with a MAC-CE communication or a downlink control information communication.

In an eighth aspect, alone or in combination with one or more of the first through seventh aspects, the one of the L1 signaling or the L2 signaling is associated with the MAC-CE communication, and the MAC-CE communication includes a cell identifier field indicating an index of the cell, and an additional information field indicating one or more of an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

In a ninth aspect, alone or in combination with one or more of the first through eighth aspects, the one of the L1 signaling or the L2 signaling is associated with the MAC-CE communication, and the MAC-CE communication indicates one or more L1 measurement and reporting configurations associated with one or more deactivated cells, of the set of cells.

In a tenth aspect, alone or in combination with one or more of the first through ninth aspects, the MAC-CE communication indicates, for each deactivated cell, of the one or more deactivated cells, a corresponding L1 measurement and reporting configuration identifier.

In an eleventh aspect, alone or in combination with one or more of the first through tenth aspects, the corresponding L1 measurement and reporting configuration identifier for each deactivated cell is indicated using a corresponding octet in the MAC-CE communication.

In a twelfth aspect, alone or in combination with one or more of the first through eleventh aspects, the MAC-CE communication indicates a single L1 measurement and reporting configuration identifier associated with the one or more deactivated cells.

In a thirteenth aspect, alone or in combination with one or more of the first through twelfth aspects, the single L1 measurement and reporting configuration identifier is indicated using a single octet in the MAC-CE communication.

In a fourteenth aspect, alone or in combination with one or more of the first through thirteenth aspects, the MAC-CE communication indicates, for each deactivated cell, of a subset of the one or more deactivated cells, a corresponding L1 measurement and reporting configuration identifier.

In a fifteenth aspect, alone or in combination with one or more of the first through fourteenth aspects, the corresponding L1 measurement and reporting configuration identifier for each deactivated cell, of the subset of the one or more deactivated cells, is indicated using a corresponding octet in the MAC-CE communication that includes a cell index field and a L1 measurement and reporting configuration identifier field.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., UE 120), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE 120, a network node 110, or another wireless communication device) using the reception component 1002 and the transmission component 1004. As further shown, the apparatus 1000 may include the communication manager 140. The communication manager 140 may include one or more of an activation/deactivation component 1008, or a measurement and reporting component 1010, among other examples.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The reception component 1002 may receive a configuration of a set of cells that support at least one of L1 signaling mobility or L2 signaling mobility, wherein each cell, of the set of cells, is associated with an SpCell configuration. The reception component 1002 may receive, via one of L1 signaling or L2 signaling, an indication of a cell, of the set of cells, to serve as an SpCell. The activation/deactivation component 1008 may activate the cell as the SpCell based at least in part on the one of the L1 signaling or the L2 signaling and a corresponding SpCell configuration associated with the cell.

The reception component 1002 may receive, via the one of the L1 signaling or the L2 signaling, an indication that another cell associated with the mobility deactivated subset of cells should be added to the mobility activated subset of cells.

The activation/deactivation component 1008 may deactivate another cell, of the set of cells, as the SpCell based at least in part on activating the cell as the SpCell, wherein the other cell becomes associated with the mobility activated subset of cells based at least in part on deactivating the other cell as the SpCell.

The activation/deactivation component 1008 may deactivate another cell, of the set of cells, as the SpCell based at least in part on activating the cell as the SpCell, wherein the other cell becomes associated with the mobility deactivated subset of cells based at least in part on deactivating the other cell as the SpCell.

The reception component 1002 may receive, via the one of the L1 signaling or the L2 signaling, an indication that the other cell should become associated with the mobility deactivated subset of cells.

The measurement and reporting component 1010 may perform, for at least one cell associated with the mobility deactivated subset of cells, L1 measurement and reporting.

The reception component 1002 may receive at least one L1 measurement and reporting configuration associated with the at least one cell.

The reception component 1002 may receive multiple L1 measurement and reporting configurations.

The reception component 1002 may receive an indication of a selected L1 measurement and reporting configuration, of the multiple L1 measurement and reporting configurations, associated with the at least one cell.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node (e.g., network node 110), or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE 120, a network node 110, or another wireless communication device) using the reception component 1102 and the transmission component 1104. As further shown, the apparatus 1100 may include the communication manager 150. The communication manager 150 may include a configuration component 1108, among other examples.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node 110 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node 110 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node 110 described in connection with FIG. 2. In some aspects, the transmission component 1104 may be co-located with the reception component 1102 in a transceiver.

The transmission component 1104 and/or the configuration component 1108 may transmit, to a UE, a configuration of a set of cells that support at least one of L1 signaling mobility or L2 signaling mobility, wherein each cell, of the set of cells, is associated with an SpCell configuration. The transmission component 1104 may transmit, to the UE via one of L1 signaling or L2 signaling, an indication of a cell, of the set of cells, to serve as an SpCell based at least in part on a corresponding SpCell configuration.

The transmission component 1104 may transmit, to the UE via the one of the L1 signaling or the L2 signaling, an indication that another cell associated with the mobility deactivated subset of cells should be added to the mobility activated subset of cells.

The transmission component 1104 may transmit, to the UE via the one of the L1 signaling or the L2 signaling, an indication that a previous SpCell should become associated with the mobility deactivated subset of cells.

The transmission component 1104 and/or the configuration component 1108 may transmit, to the UE, at least one L1 measurement and reporting configuration associated with at least one cell associated with the mobility deactivated subset of cells.

The transmission component 1104 and/or the configuration component 1108 may transmit, to the UE, multiple L1 measurement and reporting configurations.

The transmission component 1104 and/or the configuration component 1108 may transmit, to the UE, an indication of a selected L1 measurement and reporting configuration, of the multiple L1 measurement and reporting configurations, associated with the at least one cell.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a configuration of a set of cells that support at least one of L1 signaling mobility or L2 signaling mobility, wherein each cell, of the set of cells, is associated with an SpCell configuration; receiving, via one of L1 signaling or L2 signaling, an indication of a cell, of the set of cells, to serve as an SpCell; and activating the cell as the SpCell based at least in part on the one of the L1 signaling or the L2 signaling and a corresponding SpCell configuration associated with the cell.

Aspect 2: The method of Aspect 1, wherein the set of cells includes a mobility activated subset of cells and a mobility deactivated subset of cells, and wherein the cell is associated with the mobility activated subset of cells.

Aspect 3: The method of Aspect 2, further comprising receiving, via the one of the L1 signaling or the L2 signaling, an indication that another cell associated with the mobility deactivated subset of cells should be added to the mobility activated subset of cells.

Aspect 4: The method of any of Aspects 2-3, further comprising deactivating another cell, of the set of cells, as the SpCell based at least in part on activating the cell as the SpCell, wherein the other cell becomes associated with the mobility activated subset of cells based at least in part on deactivating the other cell as the SpCell.

Aspect 5: The method of any of Aspects 2-3, further comprising deactivating another cell, of the set of cells, as the SpCell based at least in part on activating the cell as the SpCell, wherein the other cell becomes associated with the mobility deactivated subset of cells based at least in part on deactivating the other cell as the SpCell.

Aspect 6: The method of Aspect 5, further comprising receiving, via the one of the L1 signaling or the L2 signaling, an indication that the other cell should become associated with the mobility deactivated subset of cells.

Aspect 7: The method of any of Aspects 2-6, further comprising performing, for at least one cell associated with the mobility deactivated subset of cells, L1 measurement and reporting.

Aspect 8: The method of Aspect 7, further comprising receiving at least one L1 measurement and reporting configuration associated with the at least one cell.

Aspect 9: The method of Aspect 8, further comprising: receiving multiple L1 measurement and reporting configurations; and receiving an indication of a selected L1 measurement and reporting configuration, of the multiple L1 measurement and reporting configurations, associated with the at least one cell.

Aspect 10: The method of any of Aspects 1-9, wherein the one of the L1 signaling or the L2 signaling includes one of a logical channel identity or a downlink control information format indicating at least one of: a cell identifier associated with the cell, an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

Aspect 11: The method of any of Aspects 1-10, wherein the one of the L1 signaling or the L2 signaling is associated with a MAC-CE communication or a downlink control information communication.

Aspect 12: The method of Aspect 11, wherein the one of the L1 signaling or the L2 signaling is associated with the MAC-CE communication, and wherein the MAC-CE communication includes a cell identifier field indicating an index of the cell, and an additional information field indicating one or more of: an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

Aspect 13: The method of any of Aspects 11-12, wherein the one of the L1 signaling or the L2 signaling is associated with the MAC-CE communication, and wherein the MAC-CE communication indicates one or more L1 measurement and reporting configurations associated with one or more deactivated cells, of the set of cells.

Aspect 14: The method of Aspect 13, wherein the MAC-CE communication indicates, for each deactivated cell, of the one or more deactivated cells, a corresponding L1 measurement and reporting configuration identifier.

Aspect 15: The method of Aspect 14, wherein the corresponding L1 measurement and reporting configuration identifier for each deactivated cell is indicated using a corresponding octet in the MAC-CE communication.

Aspect 16: The method of any of Aspect 13, wherein the MAC-CE communication indicates a single L1 measurement and reporting configuration identifier associated with the one or more deactivated cells.

Aspect 17: The method of Aspect 16, wherein the single L1 measurement and reporting configuration identifier is indicated using a single octet in the MAC-CE communication.

Aspect 18: The method of Aspect 13, wherein the MAC-CE communication indicates, for each deactivated cells, of a subset of the one or more deactivated cells, a corresponding L1 measurement and reporting configuration identifier.

Aspect 19: The method of Aspect 18, wherein the corresponding L1 measurement and reporting configuration identifier for each deactivated cell, of the subset of the one or more deactivated cells, is indicated using a corresponding octet in the MAC-CE communication that includes a cell index field and a L1 measurement and reporting configuration identifier field.

Aspect 20: A method of wireless communication performed by network node, comprising: transmitting, to a UE, a configuration of a set of cells that support at least one of L1 signaling mobility or L2 signaling mobility, wherein each cell, of the set of cells, is associated with an SpCell configuration; and transmitting, to the UE via one of L1 signaling or L2 signaling, an indication of a cell, of the set of cells, to serve as an SpCell based at least in part on a corresponding SpCell configuration.

Aspect 21: The method of Aspect 20, wherein the set of cells includes a mobility activated subset of cells and a mobility deactivated subset of cells, and wherein the cell is associated with the mobility activated subset of cells.

Aspect 22: The method of Aspect 21, further comprising transmitting, to the UE via the one of the L1 signaling or the L2 signaling, an indication that another cell associated with the mobility deactivated subset of cells should be added to the mobility activated subset of cells.

Aspect 23: The method of any of Aspects 21-22, further comprising transmitting, to the UE via the one of the L1 signaling or the L2 signaling, an indication that a previous SpCell should become associated with the mobility deactivated subset of cells.

Aspect 24: The method of any of Aspects 21-23, further comprising transmitting, to the UE, at least one L1 measurement and reporting configuration associated with at least one cell associated with the mobility deactivated subset of cells.

Aspect 25: The method of Aspect 24, further comprising: transmitting, to the UE, multiple L1 measurement and reporting configurations; and transmitting, to the UE, an indication of a selected L1 measurement and reporting configuration, of the multiple L1 measurement and reporting configurations, associated with the at least one cell.

Aspect 26: The method of any of Aspects 20-25, wherein the one of the L1 signaling or the L2 signaling includes one of a logical channel identity or a downlink control information format indicating at least one of: a cell identifier associated with the cell, an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

Aspect 27: The method of any of Aspects 20-26, wherein the one of the L1 signaling or the L2 signaling is associated with a MAC-CE communication or a downlink control information communication.

Aspect 28: The method of Aspect 27, wherein the one of the L1 signaling or the L2 signaling is associated with the MAC-CE communication, and wherein the MAC-CE communication includes a cell identifier field indicating an index of the cell, and an additional information field indicating one or more of: an SpCell configuration associated with the cell, a transmission configuration indicator state associated with the cell, a reference signal associated with a beam management procedure associated with the cell, or a reference signal identifier associated with L1 measurement and reporting of a previous SpCell that is being deactivated as the SpCell in response to activating the cell as the SpCell.

Aspect 29: The method of any of Aspects 27-28, wherein the one of the L1 signaling or the L2 signaling is associated with the MAC-CE communication, and wherein the MAC-CE communication indicates one or more L1 measurement and reporting configurations associated with one or more deactivated cells, of the set of cells.

Aspect 30: The method of Aspect 29, wherein the MAC-CE communication indicates, for each deactivated cell, of the one or more deactivated cells, a corresponding L1 measurement and reporting configuration identifier.

Aspect 31: The method of Aspect 30, wherein the corresponding L1 measurement and reporting configuration identifier for each deactivated cell is indicated using a corresponding octet in the MAC-CE communication.

Aspect 32: The method of Aspect 29, wherein the MAC-CE communication indicates a single L1 measurement and reporting configuration identifier associated with the one or more deactivated cells.

Aspect 33: The method of Aspect 32, wherein the single L1 measurement and reporting configuration identifier is indicated using a single octet in the MAC-CE communication.

Aspect 34: The method of Aspect 29, wherein the MAC-CE communication indicates, for each deactivated cell, of a subset of the one or more deactivated cells, a corresponding L1 measurement and reporting configuration identifier.

Aspect 35: The method of Aspect 34, wherein the corresponding L1 measurement and reporting configuration identifier for each deactivated cell, of the subset of the one or more deactivated cells, is indicated using a corresponding octet in the MAC-CE communication that includes a cell index field and a L1 measurement and reporting configuration identifier field.

Aspect 36: An apparatus for wireless communication at a device, comprising a processor; memory coupled with the processor; and instructions stored in the memory and executable by the processor to cause the apparatus to perform the method of one or more of Aspects 1-19.

Aspect 37: A device for wireless communication, comprising a memory and one or more processors coupled to the memory, the one or more processors configured to perform the method of one or more of Aspects 1-19.

Aspect 38: An apparatus for wireless communication, comprising at least one means for performing the method of one or more of Aspects 1-19.

Aspect 39: A non-transitory computer-readable medium storing code for wireless communication, the code comprising instructions executable by a processor to perform the method of one or more of Aspects 1-19.

Aspect 40: A non-transitory computer-readable medium storing a set of instructions for wireless communication, the set of instructions comprising one or more instructions that, when executed by one or more processors of a device, cause the device to perform the method of one or more of Aspects 1-19.

Aspect 41: An apparatus for wireless communication at a device, comprising a processor; memory coupled with the processor; and instructions stored in the memory and executable by the processor to cause the apparatus to perform the method of one or more of Aspects 20-35.

Aspect 42: A device for wireless communication, comprising a memory and one or more processors coupled to the memory, the one or more processors configured to perform the method of one or more of Aspects 20-35.

Aspect 43: An apparatus for wireless communication, comprising at least one means for performing the method of one or more of Aspects 20-35.

Aspect 44: A non-transitory computer-readable medium storing code for wireless communication, the code comprising instructions executable by a processor to perform the method of one or more of Aspects 20-35.

Aspect 45: A non-transitory computer-readable medium storing a set of instructions for wireless communication, the set of instructions comprising one or more instructions that, when executed by one or more processors of a device, cause the device to perform the method of one or more of Aspects 20-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration of a set of cells that support at least one of layer 1 (L1) signaling mobility or layer 2 (L2) signaling mobility, wherein each cell, of the set of cells, is associated with a special cell (SpCell) configuration;
receive, via one of L1 signaling or L2 signaling, an indication of a cell, of the set of cells, to serve as an SpCell; and
activate the cell as the SpCell based at least in part on the one of the L1 signaling or the L2 signaling and a corresponding SpCell configuration associated with the cell.

2. The apparatus of claim 1, wherein the set of cells includes a mobility activated subset of cells and a mobility deactivated subset of cells, and wherein the cell is associated with the mobility activated subset of cells.

3. The apparatus of claim 2, wherein the one or more processors are further configured to receive, via the one of the L1 signaling or the L2 signaling, an indication that another cell associated with the mobility deactivated subset of cells should be added to the mobility activated subset of cells.

4. The apparatus of claim 2, wherein the one or more processors are further configured to deactivate another cell, of the set of cells, as the SpCell based at least in part on activating the cell as the SpCell, wherein the other cell becomes associated with the mobility activated subset of cells based at least in part on deactivating the other cell as the SpCell.

5. The apparatus of claim 2, wherein the one or more processors are further configured to deactivate another cell, of the set of cells, as the SpCell based at least in part on activating the cell as the SpCell, wherein the other cell becomes associated with the mobility deactivated subset of cells based at least in part on deactivating the other cell as the SpCell.

6. The apparatus of claim 5, wherein the one or more processors are further configured to receive, via the one of the L1 signaling or the L2 signaling, an indication that the other cell should become associated with the mobility deactivated subset of cells.

7. The apparatus of claim 2, wherein the one or more processors are further configured to perform, for at least one cell associated with the mobility deactivated subset of cells, L1 measurement and reporting.

8. The apparatus of claim 7, wherein the one or more processors are further configured to receive at least one L1 measurement and reporting configuration associated with the at least one cell.

9. The apparatus of claim 8, wherein the one or more processors are further configured to:
receive multiple L1 measurement and reporting configurations; and
receive an indication of a selected L1 measurement and reporting configuration, of the multiple L1 measurement and reporting configurations, associated with the at least one cell.

10. The apparatus of claim 1, wherein the one of the L1 signaling or the L2 signaling includes one of a logical channel identity or a downlink control information format indicating at least one of:
a cell identifier associated with the cell,
an SpCell configuration associated with the cell,
a transmission configuration indicator state associated with the cell,
a reference signal associated with a beam management procedure associated with the cell, or
a reference signal identifier associated with L1 measurement and reporting of a previous SpCell that is being deactivated as the SpCell in response to activating the cell as the SpCell.

11. The apparatus of claim 1, wherein the one of the L1 signaling or the L2 signaling is associated with a medium access control (MAC) control element (MAC-CE) communication or a downlink control information communication.

12. The apparatus of claim 11, wherein the one of the L1 signaling or the L2 signaling is associated with the MAC-CE communication, and wherein the MAC-CE communication includes a cell identifier field indicating an index of the cell, and an additional information field indicating one or more of:
an SpCell configuration associated with the cell,
a transmission configuration indicator state associated with the cell,
a reference signal associated with a beam management procedure associated with the cell, or
a reference signal identifier associated with L1 measurement and reporting of a previous SpCell that is being deactivated as the SpCell in response to activating the cell as the SpCell.

13. The apparatus of claim 11, wherein the one of the L1 signaling or the L2 signaling is associated with the MAC-CE communication, and wherein the MAC-CE communication indicates one or more L1 measurement and reporting configurations associated with one or more deactivated cells, of the set of cells.

14. The apparatus of claim 13, wherein the MAC-CE communication indicates, for each deactivated cell, of the one or more deactivated cells, a corresponding L1 measurement and reporting configuration identifier. The apparatus of claim 14, wherein the corresponding L1 measurement and reporting configuration identifier for each deactivated cell is indicated using a corresponding octet in the MAC-CE communication.

16. The apparatus of claim 13, wherein the MAC-CE communication indicates a single L1 measurement and reporting configuration identifier associated with the one or more deactivated cells.

17. The apparatus of claim 16, wherein the single L1 measurement and reporting configuration identifier is indicated using a single octet in the MAC-CE communication.

18. The apparatus of claim 13, wherein the MAC-CE communication indicates, for each deactivated cells, of a subset of the one or more deactivated cells, a corresponding L1 measurement and reporting configuration identifier.

19. The apparatus of claim 18, wherein the corresponding L1 measurement and reporting configuration identifier for each deactivated cell, of the subset of the one or more deactivated cells, is indicated using a corresponding octet in the MAC-CE communication that includes a cell index field and a L1 measurement and reporting configuration identifier field.

20. An apparatus for wireless communication at a network node, comprising:
a memory; and
one or more processors, coupled to the memory, configured to:
transmit, to a user equipment (UE), a configuration of a set of cells that support at least one of layer 1 (L1) signaling mobility or layer 2 (L2) signaling mobility, wherein each cell, of the set of cells, is associated with a special cell (SpCell) configuration; and
transmit, to the UE via one of L1 signaling or L2 signaling, an indication of a cell, of the set of cells, to serve as an SpCell based at least in part on a corresponding SpCell configuration.

21. The apparatus of claim 20, wherein the one of the L1 signaling or the L2 signaling is associated with a medium access control (MAC) control element (MAC-CE) communication, and wherein the MAC-CE communication includes a cell identifier field indicating an index of the cell, and an additional information field indicating one or more of:
an SpCell configuration associated with the cell,
a transmission configuration indicator state associated with the cell,
a reference signal associated with a beam management procedure associated with the cell, or
a reference signal identifier associated with L1 measurement and reporting of a previous SpCell that is being deactivated as the SpCell in response to activating the cell as the SpCell.

22. The apparatus of claim 20, wherein the one of the L1 signaling or the L2 signaling is associated with a medium access control (MAC) control element (MAC-CE) communication, and wherein the MAC-CE communication indicates one or more L1 measurement and reporting configurations associated with one or more deactivated cells, of the set of cells.

23. The apparatus of claim 22, wherein the MAC-CE communication indicates, for each deactivated cell, of the one or more deactivated cells, a corresponding L1 measurement and reporting configuration identifier, and wherein the corresponding L1 measurement and reporting configuration identifier for each deactivated cell is indicated using a corresponding octet in the MAC-CE communication.

24. The apparatus of claim 22, wherein the MAC-CE communication indicates a single L1 measurement and reporting configuration identifier associated with the one or more deactivated cells, and wherein the single L1 measurement and reporting configuration identifier is indicated using a single octet in the MAC-CE communication.

25. The apparatus of claim 22, wherein the MAC-CE communication indicates, for each deactivated cell, of a subset of the one or more deactivated cells, a corresponding L1 measurement and reporting configuration identifier, and wherein the corresponding L1 measurement and reporting configuration identifier for each deactivated cell, of the subset of the one or more deactivated cells, is indicated using a corresponding octet in the MAC-CE communication that includes a cell index field and a L1 measurement and reporting configuration identifier field.

26. A method of wireless communication performed by a user equipment (UE), comprising:
receiving a configuration of a set of cells that support at least one of layer 1 (L1) signaling mobility or layer 2 (L2) signaling mobility, wherein each cell, of the set of cells, is associated with a special cell (SpCell) configuration;
receiving, via one of L1 signaling or L2 signaling, an indication of a cell, of the set of cells, to serve as an SpCell; and
activating the cell as the SpCell based at least in part on the one of the L1 signaling or the L2 signaling and a corresponding SpCell configuration associated with the cell.

27. The method of claim 26, wherein the set of cells includes a mobility activated subset of cells and a mobility deactivated subset of cells, and wherein the cell is associated with the mobility activated subset of cells.

28. The method of claim 27, further comprising performing, for at least one cell associated with the mobility deactivated subset of cells, L1 measurement and reporting.

29. A method of wireless communication performed by network node, comprising:
transmitting, to a user equipment (UE), a configuration of a set of cells that support at least one of layer 1 (L1) signaling mobility or layer 2 (L2) signaling mobility, wherein each cell, of the set of cells, is associated with a special cell (SpCell) configuration; and
transmitting, to the UE via one of L1 signaling or L2 signaling, an indication of a cell, of the set of cells, to serve as an SpCell based at least in part on a corresponding SpCell configuration.

30. The method of claim 29, wherein the one of the L1 signaling or the L2 signaling includes one of a logical channel identity or a downlink control information format indicating at least one of:
a cell identifier associated with the cell,
an SpCell configuration associated with the cell,
a transmission configuration indicator state associated with the cell,
a reference signal associated with a beam management procedure associated with the cell, or
a reference signal identifier associated with L1 measurement and reporting of a previous SpCell that is being deactivated as the SpCell in response to activating the cell as the SpCell.
